(19) United States
(12) Patent Application Publication
(10) Pub. No.: US 2017/0032853 A1
(43) Pub. Date: Feb. 2, 2017

(54) NUCLEAR FUEL ASSEMBLY WITH SEISMIC/LOCA TOLERANCE GRID

(71) Applicant: Westinghouse Electric Company LLC, Cranberry Township, PA (US)

(72) Inventors: Xiaoyan (Jane) Jiang, Columbia, SC (US); Yong (Roger) Lu, Columbia, SC (US)

(73) Assignee: Westinghouse Electric Company LLC, Cranberry Township, PA (US)

(21) Appl. No.: 14/812,466

(22) Filed: Jul. 29, 2015

(51) Int. Cl. G21C 3/34

(52) U.S. Cl. CPC G21C 3/34

(57) ABSTRACT

A nuclear fuel assembly grid that includes two zones, a protected zone and a crumbled zone. The crumbled zone occupies the periphery of the grid and is designed to experience plastic deformation under high impact loads and the protected zone occupies the interior of the grid where the control rod guide thimbles are located and protects all of the control rod guide thimble locations by experiencing only plastic deformation under such loads.

### BACKGROUND

1. Field

This invention pertains generally to a nuclear reactor fuel assembly and more particularly to a nuclear fuel assembly which employs a spacer grid that has a number of zones, one stronger than the other, with the strongest zone reserved for the control rod guide thimbles to resist deformation during a severe seismic or LOCA accident event.

2. Related Art

In most pressurized water nuclear reactors the reactor core is comprised of a large number of elongated fuel assemblies that generate the reactive power of the reactor. These fuel assemblies typically include a plurality of fuel rods held in organized array by a plurality of grids tandemly spaced axially along the fuel assembly length and attached to a plurality of elongated thimble tubes of the fuel assembly. The thimble tubes typically receive control rods or instrumentation therein. Top and bottom nozzles are affixed on opposite ends of the fuel assembly and are secured to the ends of the thimble tubes that extend slightly above and below the ends of the fuel rods.

The grids, as is known in the relevant art, are used to precisely maintain the spacing and support between the fuel rods in the reactor core, provide lateral support for the fuel rods and induce mixing of the coolant. One type of conventional grid design includes a plurality of interleaved straps that together form an egg-crate configuration having a plurality of roughly square cells which individually accept the fuel rods therein. Depending upon the configuration of the thimble tubes, the thimble tubes can either be received in cells that are sized the same as those that receive fuel rods therein, or in relatively larger thimble cells defined in the interleaved straps. The interleaved straps provide attachment points to the thimble tubes, thus enabling positioning of the grids at spaced locations along the length of the fuel assembly.

The straps are configured such that the cells through which the fuel rods pass each include one or more relative compliant springs and a plurality of relatively rigid dimples which cooperate to form the fuel rod support feature of the grid. The springs and dimples may be formed in the middle of the interleaved straps and protrude outwardly therefrom into the cells through which the fuel rods pass. The springs and dimples of each fuel rod cell then contact the corresponding fuel rod extending through the cell. Outer straps of the grid are attached together and peripherally enclose the inner straps of the grid to impart strength and rigidity to the grid and define individual fuel rod cells around the perimeter of the grid. The inner straps are typically welded or brazed at each intersection and the inner straps are also welded or brazed to the peripheral or outer straps defining the outer perimeter of the assembly.

At the individual cell level, the fuel rod support is normally provided by the combination of rigid support dimples and flexible springs as mentioned above. There are many variations to the spring-dimple support geometry that have been used or are currently in use, including diagonal springs, “I” shaped springs, cantilevered springs, horizontal and vertical dimples, etc. The number of springs and dimples per cell also varies. The typical arrangement is two springs and four dimples per cell. The geometry of the dimples and springs needs to be carefully determined to provide adequate rod support through the life of the assembly.

During irradiation, the initial spring force relaxes more or less rapidly depending on the spring material and irradiation environment. The cladding diameter also changes as a result of the very high coolant pressure and operating temperatures and the fuel pellets inside the rod also change their diameter by densification and swelling. The outside cladding diameter also increases due to the formation of an oxide layer. As a result of these dimensional and material property changes, maintaining adequate rod support through the life of the fuel assembly is very challenging.

Under the effect of axial flow and cross flow induced by thermal and pressure gradients within the reactor, and other flow disturbances such as standing waves and eddies, the fuel rods, which are slender bodies, are continuously vibrating with relatively small amplitudes. If the rods are not properly supported, this very small vibration amplitude may lead to relative motion between the support points and the cladding. If the pressure exerted by the sliding rod on the relatively small dimple and grid support surfaces is high enough, the small corrosion layer on the surface of the cladding can be removed by abrasion exposing the base metal to the coolant. As a new corrosion layer is formed on the exposed fresh cladding surface, it is removed by abrasion until ultimately the wall of the rod is perforated. This phenomenon is known as corrosion fretting and in 2006 it was the leading cause of fuel failures in pressurized water reactors.

Support grids also provide another important function in the fuel assembly, that of coolant mixing to decrease the maximum coolant temperature. Since the heat generated by each fuel rod is not uniform, there are thermal gradients in the coolant. One important parameter in the design of the fuel assemblies is to maintain the efficient heat transfer from the fuel rods to the coolant. The higher the amount of heat removed per unit time, the higher the power being generated. At high enough coolant temperatures, the rate of heat that can be removed per unit of cladding area in a given time decreases abruptly in a significant way. This phenomenon is known as deviation from nucleate boiling or DNB. If within the parameters of reactor operation, the coolant temperature would reach the point of DNB, the cladding surface temperature would increase rapidly in order to evacuate the heat generated inside the fuel rod and rapid cladding oxidation would lead to cladding failure. It is clear that DNB needs to be avoided to prevent fuel rod failures. Since DNB, if it occurs, takes place at the point where the coolant is at its maximum temperature, it follows that decreasing the maximum coolant temperature by coolant mixing within the assembly permits the generation of a larger amount of power without reaching DNB conditions. Normally, the improved mixing is achieved by mixing vanes in the down flow side of the grid structure. The effectiveness of mixing is dependent upon the shape, size and location of the mixing vanes relative to the fuel rods.

Other important functions of the grid include the ability to sustain handling and normal operation at anticipated accident loads without losing function and to avoid “hot spots” on the fuel rods due to the formation of steam pockets between the fuel rods and the support points, which may result when not enough coolant is locally available to evacuate the heat generated in the fuel rod. Steam pockets cause overheating of the fuel rod to the point of failure by rapid localized corrosion of the cladding.

Another important function of the grid is to resist deformation of the guide thimbles during a LOCA (Loss Of Coolant Accident) or severe seismic event in which the grids of one assembly bounce off the grids of another adjoining assembly. Such a situation could lead to deformation of some of the guide thimbles and prevent full insertion of a control rod.

Maintaining a substantially balanced coolant flow through the fuel assemblies across the core is a desirable objective to maintain substantially uniform heat transfer. Any changes in fuel assembly design can alter the pressure drop and affect the relative balance in flow resistance through the core among the various types of fuel assemblies. Changes in grid design that reduce pressure drop are desirable because such changes enable a fuel assembly designer to introduce other improvements that will restore the pressure drop equilibrium among fuel assemblies and improve other dynamics of the grid such as mixing.

Another important dynamic of a grid is to promote the efficiency of the nuclear reactions within the core by minimizing the amount of neutrons that are absorbed by the grid material while providing sufficient strength to support the fuel rods and prevent the guide thimbles from distorting. It is an object of this invention to improve the crush resistance of the grids in critical areas while minimizing the amount of additional material that is needed to be used for this purpose.

### SUMMARY

The foregoing objective is achieved employing a nuclear fuel assembly having a top nozzle, a bottom nozzle and one or more control rod guide thimbles extending between the top nozzle and the bottom nozzle. A plurality of elongated fuel rods axially extend between the top nozzle and the bottom nozzle with the elongated fuel rods and the one or more control rod guide thimbles laterally spaced between the top nozzle and the bottom nozzle by a structural grid assembly. The grid assembly comprises at least two types of lateral crush zones, respectively having different strengths, with the control rod guide thimbles occupying at least one of the at least two types of lateral crush zones having a higher lateral crush strength than at least some of other of the lateral crush zones. Such a grid may comprise a plurality of orthogonal straps configured in an egg-crate shaped pattern with an intersection between four adjacent straps forming a support cell, wherein an area of the straps surrounding the support cells supporting the control rod guide thimbles has more material to establish a higher crush strength than some of the support cells that support fuel rods. Preferably, the intersection between four adjacent straps that form support cells that support guide thimbles includes welds at the intersections of the four adjacent straps that are more robust than welds at the intersection of the four adjacent straps that support some of the fuel rods.

In one embodiment, the at least two lateral crush zones include a crumble zone and a protected zone with the crumble zone extending around a periphery of the structural grid and the protected zone extending around an interior of the structural grid. In such an arrangement, the structural grid may include a plurality of substantially square support cells wherein the crumble zone comprises at least the outer two rows of support cells. Preferably, in such an arrangement, the majority of the support cells in the structural grid occupy the protected zone within the interior of the structural support grid.

The invention also contemplates a structural grid having the foregoing characteristics.

### BRIEF DESCRIPTION OF THE DRAWINGS

A further understanding of the invention can be gained from the following description of the preferred embodiments when read in conjunction with the accompanying drawings in which:

FIG. 1 is an elevational view, partially in section, of a fuel assembly illustrated in vertically shortened form, with parts broken away for clarity;

FIG. 2 is a plan view of a conventional egg-crate support grid for application to a traditional pressurized water reactor fuel assembly such as is shown in FIG. 1;

FIG. 3 is a schematic plan view of a 17×17 grid assembly with the outer two columns and rows forming the crushable zone;

FIG. 4 is a schematic plan view of a 15×15 grid assembly in which the outer two columns and rows form the crushable zone; and

FIG. 5 is a schematic plan view of a 14×14 fuel assembly with the outer two columns and rows forming a crushable zone.

### DESCRIPTION OF THE PREFERRED EMBODIMENT

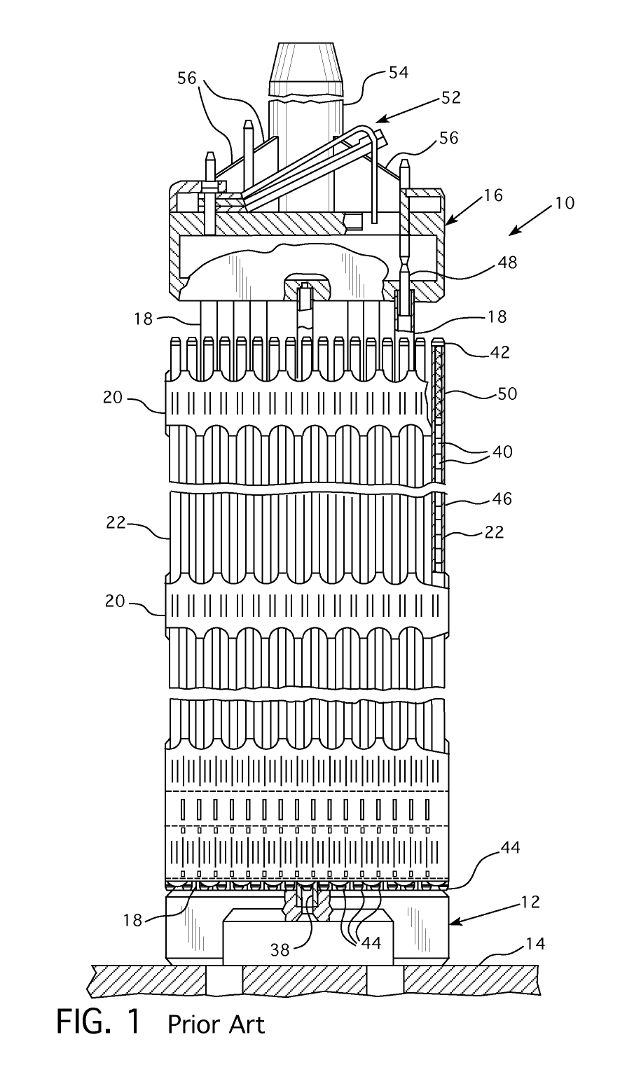

FIG. 1 is an elevational view, represented in vertically shortened form, of a nuclear fuel assembly being generally designated by reference character 10. The fuel assembly 10 is the type used in a pressurized water reactor and has a structural skeleton which, at its lower end includes a bottom nozzle 12. The bottom nozzle 12 supports the fuel assembly 10 on a lower core plate 14 in the core region of the nuclear reactor. In addition to the bottom nozzle 12, the structural skeleton of the fuel assembly 10 also includes a top nozzle 16 at its upper end and a number of guide tubes or thimbles 18 which align with guide tubes in the upper internals of the reactor. The guide tubes or thimbles 18 extend longitudinally between the bottom nozzle and top nozzles 12 and 16 and at opposite ends are rigidly attached thereto.

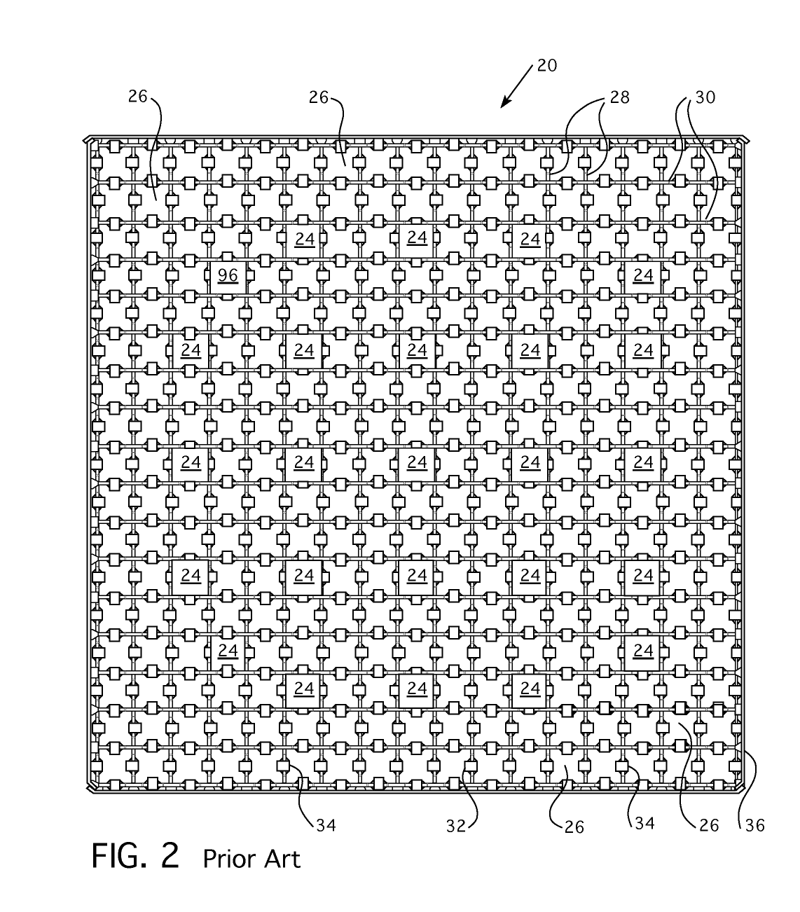

The fuel assembly 10 further includes a plurality of transverse grids 20 axially spaced along and mounted to the guide thimbles 18 and an organized array of elongated fuel rods 22 transversely spaced and supported by the grids 20. A plan view of a conventional grid 20 without the guide thimbles 18 and fuel rods 22 is shown in FIG. 2. The guide thimbles 18 pass through the cells labeled 24 and the fuel rods 22 occupy the remaining cells 26 except for the center cell 24 which is reserved for an instrument thimble 38 (shown in FIG. 1). As can be seen from FIG. 2, the grids 20 are conventionally formed from an array of orthogonal straps 28 and 30 that are interleaved in an egg-crate pattern with the adjacent interface of four straps defining approximately square support cells through which the fuel rods 22 are supported in the cells 26 in transverse, spaced relationship with each other. In many designs, springs 32 and dimples 34 are stamped into opposite walls of the straps 28 and 30 that form the support cells 26. The springs and dimples extend radially into the support cells and capture the fuel rods 22 therebetween; exerting pressure on the fuel rod cladding to hold the rods in position. The orthogonal array of straps 28 and 30 is welded at each strap end to a bordering strap 36 to complete the grid structure 20. In the prior art embodiment shown in FIG. 2, the bordering strap 36 is formed from four separate straps welded together at the corners. Also, as previously mentioned, the assembly 20 as shown in FIG. 1, has an instrumentation tube 38 located in the center thereof that extends between and is captured by the bottom and top nozzles 12 and 16. With such an arrangement of parts, fuel assembly 10 forms an integral unit capable of being conveniently handled without damaging the assembly of parts.

As mentioned above, the fuel rods 22 in the array thereof in the assembly 10 are held in spaced relationship with one another by the grids 20 spaced along the fuel assembly length. As shown in FIG. 1, each fuel rod 22 includes a plurality of nuclear fuel pellets 40 and is closed at its opposite ends by upper and lower end plugs 42 and 44. Commonly, a plenum spring 50 is disposed between the upper end plug 42 and the pellets 40 to maintain the pellets in a tight stacked relationship within the fuel rod 22. The fuel pellets 40 composed of fissile material, are responsible for creating the reactive power of the nuclear reactor. A liquid moderator/coolant, such as water, or water-containing boron, is pumped upwardly through the fuel assemblies of the core in order to extract the heat generated therein for the production of useful work. The cladding 46 which surrounds the pellets 40 functions as a barrier to prevent to the fission byproducts from entering the coolant and further contaminating the reactor system.

To control the fission process, a number of control rods 48 are reciprocally movable in the guide thimbles 18 located at predetermined positions in the fuel assembly 10. The guide thimble locations are shown in FIG. 2, and include all of the positions labeled 24, except for the center location which is occupied by the instrumentation tube 38. Specifically, a rod cluster control mechanism 52, positioned above the top nozzle 16, supports a plurality of control rods 48. The control mechanism has internally threaded cylindrical hub member 54 with a plurality of radially extending flukes or arms 56 that form a configuration commonly known as a spider. Each arm 56 is interconnected to a control rod 48 such that the control rod mechanism 52 is operable to move the control rods vertically in the guide thimbles 18 to thereby control the fission process in the fuel assembly 10, under the motive power of a control rod drive shaft which is coupled to the control rod hub 54, all in a well-known manner.

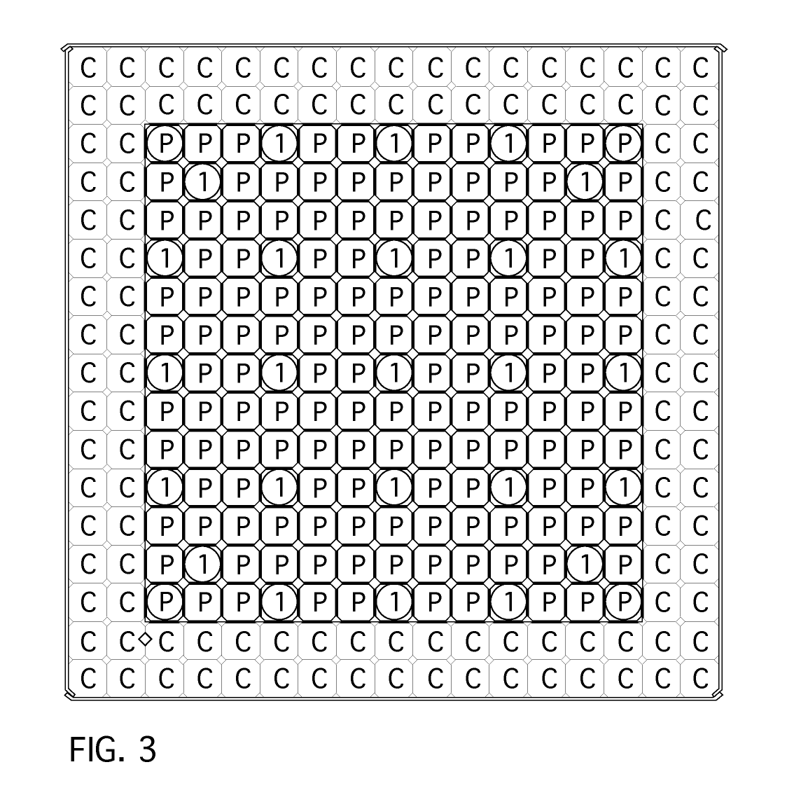

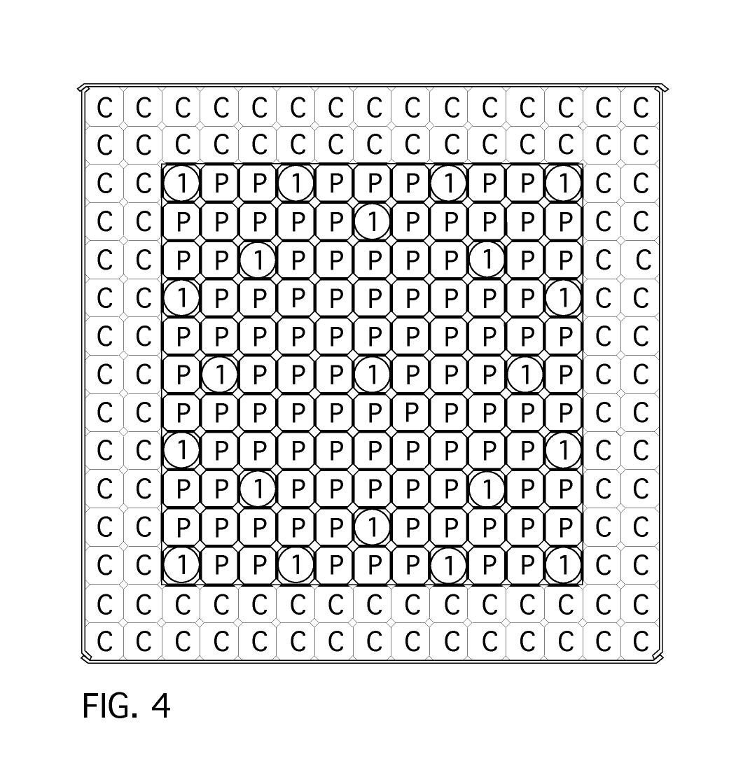

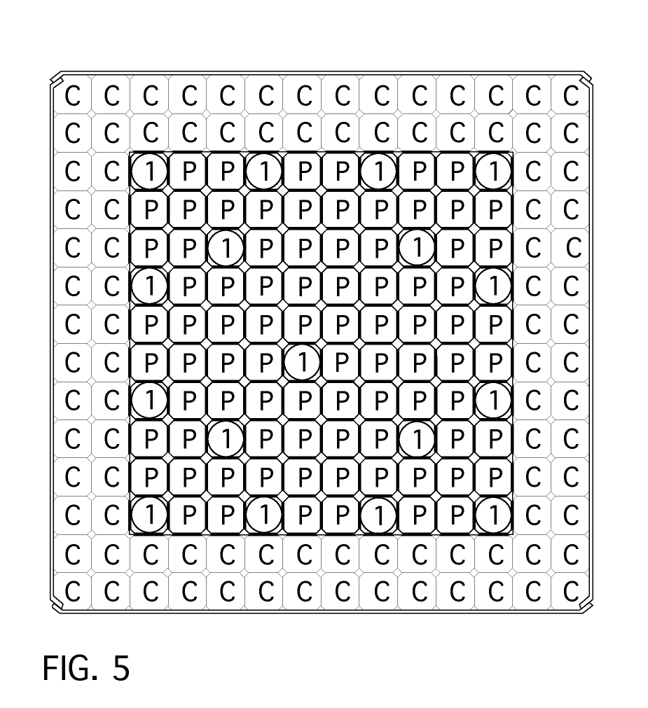

After the Fukushima Dai-ichi earthquake, fuel assembly designs are expected to tolerate the higher seismic conditions that were experienced during that event. High seismic loads can result in high grid impact forces, which can exceed the grid strength limit and deform the grids. If that occurs at the grids receiving the rod cluster control assemblies, the ability to move the control rods within the corresponding guide thimbles will be questionable. This invention provides a means of absorbing that relatively high impact energy by strengthening the control rod guide thimble locations, while providing a minimum of additional grid material to achieve that strength and, thus, minimizing any negative impact on the neutron population available to sustain the nuclear reactions within the core. This is achieved by dissipating the impact energy in certain specially designed zones over the grid and to allow these zones that only support fuel rods to somewhat crumble, i.e., have some plastic deformation. In this way the plastic deformation will absorb the impact energy. A protected zone in the grid is also provided in the area of the guide thimbles which will limit the structure deformation of the guide thimbles, in the elastic region. All thimble tube locations will be in a protected area. With this improvement, the grid retains its original thimble tube locations and dimensions in the guide thimble areas that experience only limited elastic deformation during the severe seismic or LOCA accident events. This design can better tolerate severe loads and maintain rod cluster control assembly insertability during the high seismic and LOCA events. The grid protected zone and the crumble zone are shown in FIGS. 3, 4 and 5 with FIG. 3 showing a 17×17 grid assembly, FIG. 4 showing a 15×15 grid assembly, and FIG. 5 showing a 14×14 grid assembly. In each case the support cells in the crumble zone are represented by “C”, the support cells in the protected zone are represented by “P” and the thimble tube locations are represented by a circled “1”. Preferably, the crumble zone is formed in the outermost two columns and rows of support cells and the protected zone encompasses all the remaining interior support cells. The grid straps are designed slightly differently from the current straps based on the maximum and minimum of material rules and all dimensions will be very close to the current allowable dimensions. This means, that the overall grid material volume at a given location will remain the same as the current grids. To achieve this, the slots in the grid straps are modified to increase the cell buckling strength at the protected zone. The dimple cutoffs are designed to keep the maximum material on the straps for the protected zone while providing the necessary stiffness required for the dimples. Welding tag sizes are also adjusted to satisfy the protected zone requirement.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear fuel assembly comprising;
a top nozzle;
a bottom nozzle;
a plurality of control rod guide thimbles extending between the top nozzle and the bottom nozzle;
a plurality of elongated fuel rods axially extending between the top nozzle and bottom nozzle with the elongated fuel rods and the one or more control rod guide thimbles laterally spaced between the top nozzle and the bottom nozzle by a structural grid assembly, wherein the grid assembly comprises at least two types of lateral crush zones respectively having different strengths with the control rod guide thimbles occupying at least one of the at least two types of lateral crush zones having a higher lateral crush strength than at least some other of the lateral crush zones.

2. The nuclear fuel assembly of claim 1 wherein the structural grid comprises a plurality of orthogonal straps configured in an egg-crate shaped pattern with an intersection between four adjacent straps forming a support cell wherein an area of the straps surrounding the support cells supporting the control rod guide thimbles has more material to establish a higher crush strength than some of the support cells that support fuel rods.

3. The nuclear fuel assembly of claim 2 wherein the intersection between four adjacent straps that form support cells that support guide thimbles includes welds at the intersections of the four adjacent straps that is more robust than welds at the intersection of the four adjacent straps that support some of the fuel rods.

4. The nuclear fuel assembly of claim 1 wherein the at least two lateral crush zones include a crumble zone and a protected zone with the crumble zone extending around a periphery of the structural grid and the protected zone extending around an interior of the structural grid.

5. The nuclear fuel assembly of claim 4 wherein the structural grid includes a plurality of substantially square support cells wherein the crumble zone comprises at least the outer two lateral or radial extent of support cells.

6. The nuclear fuel assembly of claim 5 wherein the majority of the support cells in the structural grid occupy the protected zone within an interior of the structural support grid.

7. A structural grid for a nuclear fuel assembly comprising:
a top nozzle;
a bottom nozzle;
one or more control rod guide thimbles extending between the top nozzle and the bottom nozzle;
a plurality of elongated fuel rods axially extending between the top nozzle and bottom nozzle with the elongated fuel rods and the one or more control rod guide thimbles laterally spaced between the top nozzle and the bottom nozzle by a structural grid assembly;
wherein the grid assembly comprises at least two types of lateral crush zones respectively having different strengths with the control rod guide thimbles occupying at least one of the at least two types of lateral crush zones having a higher lateral crush strength than at least some other of the lateral crush zones.

8. The structural grid of claim 7 comprising a plurality of orthogonal straps configured in an egg-shaped pattern with an intersection between four adjacent straps forming a support cell wherein the an area of the straps surrounding the support cells supporting the control rod guide thimbles has more material to establish a higher crush strength than some of the support cells that support fuel rods.

9. The structural grid of claim 8 wherein the intersection between four adjacent straps the form support cells that support guide thimbles includes welds at the intersections of the four adjacent straps that is more robust than welds at the intersection of the four adjacent straps that support some of the fuel rods.

10. The structural grid of claim 7 wherein the at least two lateral crush zones include a crumble zone and a protected zone with the crumble zone extending around a periphery of the structural grid and the protected zone extending around an interior of the structural grid.

11. The structural grid of claim 10 wherein the structural grid includes a plurality of substantially square support cells wherein the crumble zone comprises at least the outer two lateral or radial extent of support cells.

12. The structural grid of claim 11 wherein the majority of the support cells in the structural grid occupy the protected zone within an interior of the structural support grid.
